(19) United States
(12) Patent Application Publication
(10) Pub. No.: US 2024/0413469 A1
(43) Pub. Date: Dec. 12, 2024

(54) BATTERY MODULE AND BATTERY PACK

(71) Applicant: HONDA MOTOR CO., LTD., Tokyo (JP)

(72) Inventors: Satoshi TAKADA, Tokyo (JP); Takahiro TAKAI, Tokyo (JP); Shinya NAKAYAMA, Tokyo (JP); Yuki MATSUSHIMA, Tokyo (JP); Eiji YAMADA, Tokyo (JP); Hiroki MAEMOTO, Tokyo (JP); Fumio SATO, Tokyo (JP); Noriaki SHIGEMATSU, Tokyo (JP)

(21) Appl. No.: 18/679,762

(22) Filed: May 31, 2024

(30) Foreign Application Priority Data
Jun. 9, 2023 (JP) 2023-095753

(51) Int. Cl. H01M 50/289; H01M 50/249; H01M 50/262

(52) U.S. Cl. CPC H01M 50/289; H01M 50/262; H01M 50/249

(57) ABSTRACT

A battery module includes: a stacked body in which a plurality of secondary batteries are stacked; and a side restraint member which faces a first surface of the stacked body, and which extends in a stacked direction of the stacked body. The first surface is a surface in a vertical direction with respect to a lower surface of the stacked body, and is a surface along the stacked direction, and the first surface and the side restraint member are joined with each other by a joining member.

### CROSS-REFERENCE TO RELATED APPLICATION(S)

This application claims priority to and the benefit of Japanese Patent Application No. 2023-095753 filed on Jun. 9, 2023, the entire disclosure of which is incorporated herein by reference.

### BACKGROUND OF THE INVENTION

### Field of the Invention

The present invention relates to a battery module and a battery pack.

### Description of the Related Art

In these years, research and development on secondary batteries that contribute to energy efficiency are conducted so that more people are able to access energy that is affordable, reliable, sustainable, and advanced.

International Publication No. 2019/167689 discloses, as a configuration of a battery module, a stacked body in which a plurality of battery cells (secondary batteries) are stacked, a pair of binding bars, and a pair of end plates. The pair of binding bars are members that restrain the stacked direction of the plurality of battery cells, and the pair of end plates are members that restrain the width direction (a direction that intersects the stacked direction) of the battery cells. The pair of binding bars and the pair of end plates are component parts mainly intended to hold and protect the stacked body of the plurality of battery cells.

A battery pack is formed by mounting (disposing) a plurality of battery modules in a housing (a case) for protecting a plurality of battery modules from external force. The housing of the battery pack is provided with a structural member such as a cross member or a side frame for the purpose of ensuring strength rigidity and external force resistance performance and being coupled with the vehicle.

The cross member is a structural member that extends along the stacked direction of the plurality of battery cells in the housing, and is a structural member that extends in the same direction as that of the binding bar that restrains the plurality of battery cells in the stacked direction. In addition, the side frame is a structural member that extends in a disposed direction of the plurality of battery cells in the housing (a direction that intersects the stacked direction), and is a structural member that extends in the same direction as that of the end plate that restrains the width direction of the battery cells.

The cross member and the side frame contribute to the strength rigidity and the external force resistance performance in a longitudinal direction of the vehicle and a left-right direction of the vehicle in the housing of the battery pack, and the plurality of battery modules are held and protected in the housing by the cross member or the side frame.

The structural member (the cross member or the side frame) provided in the housing and the structural member (the binding bar or the end plate) that constitutes a battery module are, however, provided independently of each other. Hence, it may be inefficient from the viewpoint of cost, weight, and ensuring the space for mounting the battery module in the housing.

If trying to fix the battery module with the binding bar and the end plate and holding the plurality of battery modules with the cross member and the side frame to ensure the strength rigidity and the external force resistance performance, the weight of the battery module will increase. Hence, there is a demand for suppressing an increase in weight.

In addition, the structural member (the binding bar or the end plate) that constitutes the battery module and the structural member (the cross member or the side frame) provided in the housing (hereinafter, also referred to as a case) partially occupy the mounting space of the battery cell inside the case. Hence, there is a demand for improving mount efficiency of the battery module including the secondary batteries.

In view of the above issues, the present application provides a battery module in which improvement in mount efficiency is enabled, while an increase in weight of the battery module is suppressed.

### SUMMARY OF THE INVENTION

According to one aspect of the present invention, there is provided a battery module comprising: a stacked body in which a plurality of secondary batteries are stacked; and a side restraint member which faces a first surface of the stacked body, and which extends in a stacked direction of the stacked body, wherein the first surface is a surface in a vertical direction with respect to a lower surface of the stacked body, and is a surface along the stacked direction, and the first surface and the side restraint member are joined with each other by a joining member.

According to another aspect of the present invention, there is provided a battery pack in which a plurality of battery modules are disposed in a case, wherein each of the plurality of battery modules comprising: a stacked body in which a plurality of secondary batteries are stacked; and a side restraint member which faces a first surface of the stacked body, and which extends in a stacked direction of the stacked body, wherein the first surface is a surface in a vertical direction with respect to a lower surface of the stacked body, and is a surface along the stacked direction, and the first surface and the side restraint member are joined with each other by a joining member.

According to the present invention, it is possible to provide a battery module in which improvement in mount efficiency is enabled, while an increase in weight of the battery module is suppressed.

### BRIEF DESCRIPTION OF THE DRAWINGS

FIG. 1 is a view for schematically describing configurations of a battery module according to an embodiment and a battery module group;

FIG. 2 is a view for describing a joining structure between a battery cell and a side restraint member according to an embodiment;

FIG. 3 is a view for describing a structure in which the battery module group according to an embodiment is disposed in a case;

FIG. 4 is a view illustrating a coupling structure example 1 for coupling between end restraint members according to an embodiment;

FIG. 5 is a view illustrating a coupling structure example 2 for coupling between end restraint members according to an embodiment;

FIG. 6 is a view illustrating a coupling structure example 3 for coupling between end restraint members according to an embodiment; and

FIG. 7 is a view illustrating a cross-sectional structure of the battery cell according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### Battery Module 110 and Battery Module Group 115

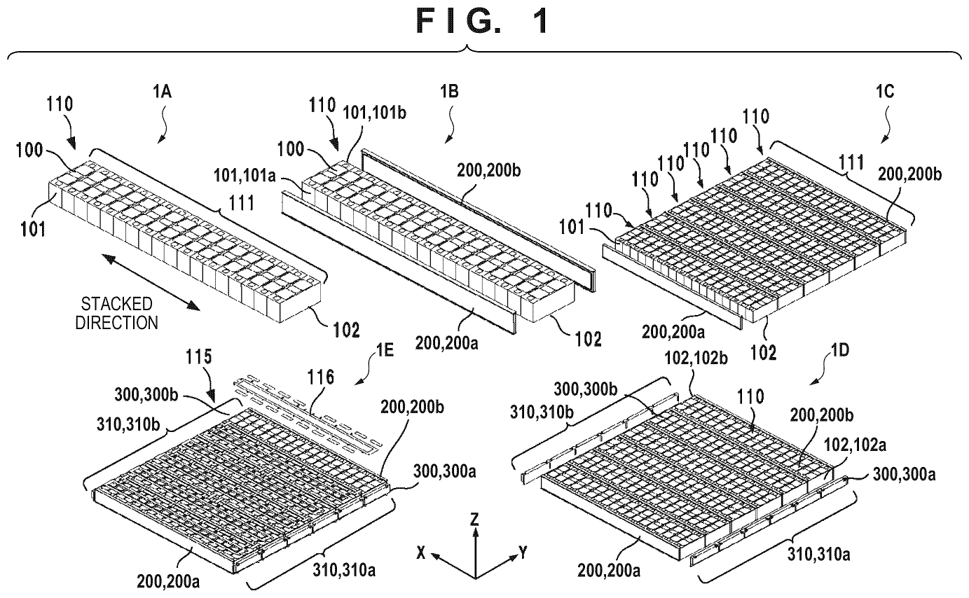

FIG. 1 is a view schematically describing configurations of a battery module 110 according to an embodiment and a battery module group 115.

In FIG. 1, as illustrated in 1A, a plurality of battery cells 100 (secondary batteries) are disposed in X direction (a stacked direction), and a stacked body 111, in which a plurality of battery cells 100 are stacked, is configured. A heat insulation material, not illustrated, may be disposed between the battery cells 100, which are disposed in X direction.

In FIG. 1, X direction (the stacked direction) of the stacked body 111 is defined as a first direction. In addition, a direction (Y direction) that intersects surfaces (XZ plane: first surfaces 101) of the plurality of battery cells 100, that is, surfaces (XZ plane: the first surfaces 101) of the battery module 110 (the stacked body 111) is defined as a second direction (an intersecting direction). A direction that intersects the first direction and the second direction is defined as a third direction (a vertical direction).

In addition, a surface (XZ plane) of the battery cell 100 and a surface (XZ plane) of the battery module 110 (the stacked body 111) in X direction and Z direction are defined as the first surface 101, and a surface (YZ surface) of the battery cell 100 and a surface (YZ surface) of the battery module 110 (the stacked body 111) in Y direction and Z direction are defined as a second surface 102.

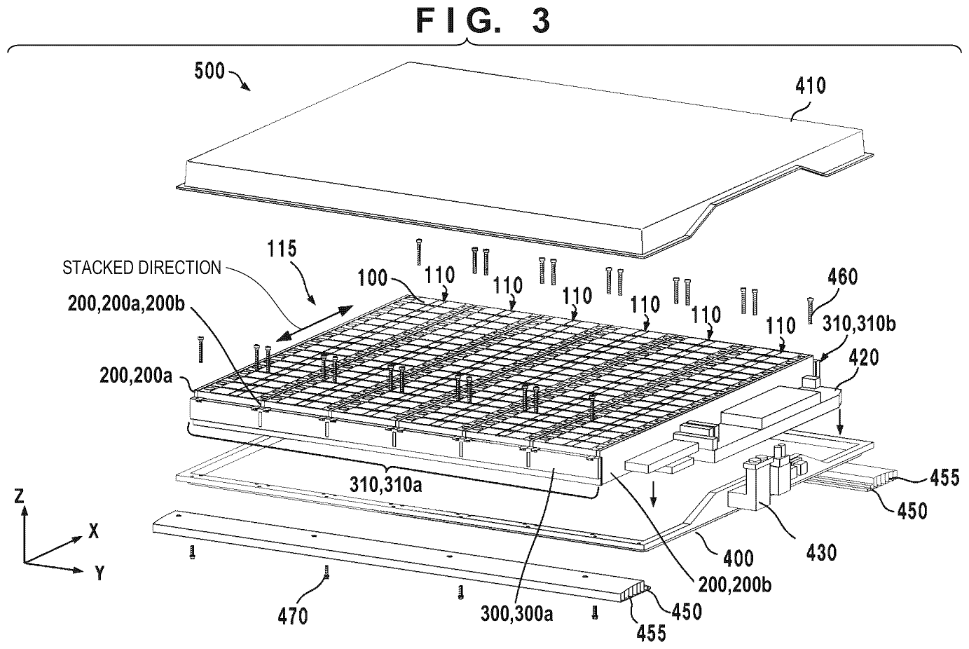

The first surface 101 is a surface in a vertical direction with respect to a lower surface (XY plane) of the battery module 110 (the stacked body 111), and is a surface along the stacked direction. In addition, the second surface 102 is a surface in the vertical direction with respect to the lower surface (XY plane) of the battery module 110 (the stacked body 111), and is a surface that intersects the stacked direction. Here, the lower surface (XY plane) of the stacked body 111 is a surface on which the stacked body 111 is disposed in a case 400 (a battery case: FIG. 3).

The surface (XZ plane) of the battery module 110 (the stacked body 111) is a surface constituted of surfaces (XZ plane: the first surfaces 101) of the plurality of battery cells 100. In addition, the surface (YZ plane) of the battery module 110 (the stacked body 111) is a surface (YZ plane: the second surface 102) in Y direction and Z direction of the battery cell 100, which is disposed at an end portion of the plurality of battery cells 100, which constitute the stacked body 111.

As illustrated in 1B of FIG. 1, side restraint members 200 (200a, 200b) face the first surfaces 101 (XZ plane) of the battery module 110 (the stacked body 111), and extend in X direction (the stacked direction) of the stacked body 111.

The first surfaces 101 (XZ plane) of the respective battery cells 100, which constitute the stacked body 111, and the side restraint members 200 (200a, 200b) are joined with each other by a joining member.

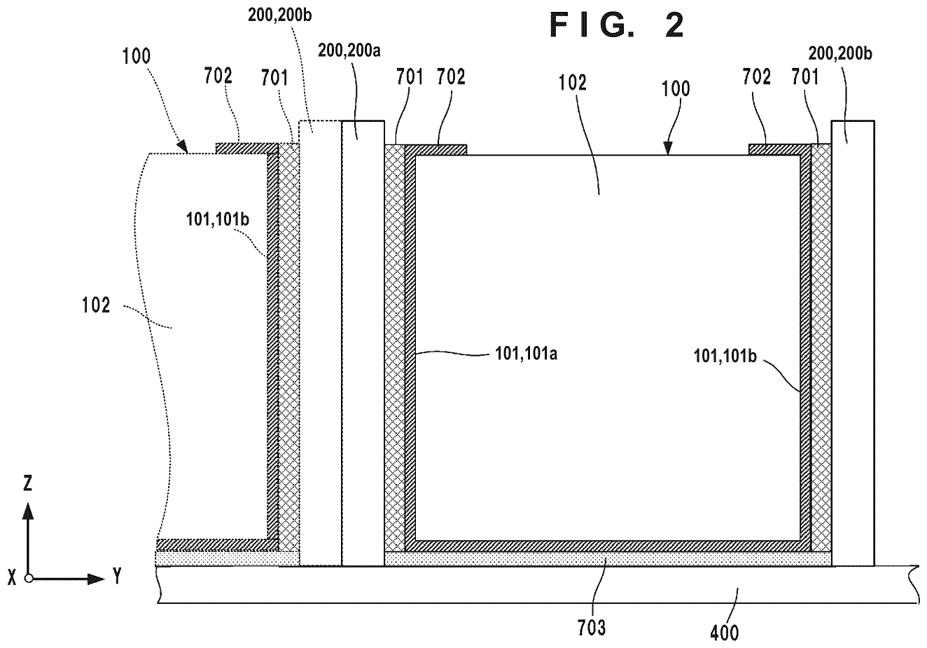

FIG. 2 is a view for describing a joining structure between the battery cell 100 and the side restraint member 200. FIG. 2 is a view of the battery cell 100 when viewed from YZ plane (the second surface 102), and an insulating film 702 is provided between a joining member 701 (for example, an adhesive or a double-sided tape) and the battery cell 100. The insulating film 702 is provided to cover an interface with the joining member 701, and in addition, to cover the lower surface and a part of an upper surface of the battery cell 100. The type of the insulating film 702 is not particularly limited, and may be a resin material. The resin material may contain, for example, polyethylene terephthalate (PET), polytetrafluoroethylene (PTFE), or the like.

A gap between battery cell 100 and the case 400 (the battery case) is filled with a filler 703. The type of the filler 703 is not particularly limited, and may be a resin material. For the insulating film 702 and the filler 703, a flame-retardant member may be used to be capable of coping with also when being exposed to high temperature due to thermal runaway of the battery cell 100.

In a case where an adhesive is used as the joining member 701, it is sufficient if the first surfaces 101 (XZ plane) and the side restraint member 200 are joined by filling the adhesive between them. The type of the adhesive is not particularly limited, and examples thereof include an acrylic resin, a urethane-based resin, a silicon-based resin, an epoxy-based resin, and an olefin-based resin.

In a side view of YZ plane (the second surface 102), the side restraint member 200 joined with the left side on a sheet surface of the battery cell 100 will be referred to as the side restraint member 200 (200a). The side restraint member 200 joined with the right side on the sheet surface of the battery cell 100 will be referred to as the side restraint member 200 (200b). The description of the “side restraint member 200” or “side restraint members 200 (200a, 200b)” denotes a generic name of the side restraint member 200 (200a) and the side restraint member 200 (200b).

In addition, the first surface 101 (XZ plane) on the left side on the sheet surface of the battery cell 100 will be referred to as the first surface 101 (101a), and the first surface 101 (XZ plane) on the right side on the sheet surface of the battery cell 100 will be referred to as the first surface 101 (101b). The expression of the “first surface 101” or “first surface 101 (XZ plane)” denotes a generic name of the first surfaces 101 (101a) and the first surfaces 101 (101b).

The first surface 101 (101a) and the first surface 101 (101b) of the battery cell 100 have a similar joining structure.

In the battery cells 100 illustrated in FIG. 2, the battery cell 100, which is indicated by a broken line, represents another battery cell 100, which is disposed to be adjacent to the battery cell 100, which is indicated by a solid line along Y direction. The side restraint member 200 (200b), which is indicated by a broken line, is joined with the battery cell 100 by a joining structure similar to that of the side restraint member 200 (200a).

In FIG. 2, the side restraint member 200 (200a) faces the first surface 101 (101a) on one end side in Y direction, and the side restraint member 200 (200b) faces the first surface 101 (101b) on the other end side in Y direction.

The side restraint members 200 (200a, 200b) are each a plate-shaped member made of, for example, metal such as aluminum, an aluminum alloy, copper, iron, an iron alloy, or stainless steel. The shape of the side restraint members 200 (200a, 200b) is not particularly limited, as long as it is possible to hold and restrain the first surfaces 101 (101a, 101b: XZ plane) of each battery cell 100, which constitutes the battery module 110 (the stacked body 111).

As illustrated in 1B of FIG. 1 and FIG. 2, in a side view of YZ plane (the second surface 102), the pair of side restraint members 200 (200a, 200b) face the first surfaces 101 (101a) on one end side in Y direction and the first surfaces 101 (101b) on the other end side in Y direction of YZ plane (the second surface 102) of the stacked body 111 (the battery cells 100), and extend in the stacked direction of the stacked body 111 (the battery cells 100).

The side restraint members 200 (200a, 200b) each can function as a member for holding and restraining the stacked direction (X direction: the first direction) of the battery module 110 (the stacked body 111), also giving the strength rigidity to the battery module 110 (the stacked body 111), and protecting the battery module 110.

As illustrated in 1C of FIG. 1, in the case (400 of FIG. 3) in which the battery module 110 (the stacked body 111) is disposed, a plurality of the battery modules 110 (the stacked bodies 111) are disposed in a second direction (Y direction) that is vertical with respect to the lower surface of the stacked body 111, and that intersects the stacked direction.

The side restraint members 200 (200a) respectively face, in the second direction, another side restraint members 200 (200b) of another battery module 110, which is disposed to be adjacent in the case (400 in FIGS. 2 and 3).

For example, out of the plurality of battery modules 110, the side restraint member 200 (for example, a solid line in FIG. 2) of one battery module 110 and the other side restraint member 200 (for example, a broken line in FIG. 2) of the other battery module 110, which is disposed to be adjacent along the second direction (Y direction), are disposed in the case 400, in a state in which they face each other in the second direction.

As illustrated in 1D of FIG. 1, the battery module 110 further includes an end restraint member 300, which holds YZ plane (the second surface 102) of the battery module 110 (the stacked body 111), and is coupled with the side restraint members 200.

In 1D of FIG. 1, in a side view of XZ plane (the first surfaces 101), the end restraint member 300 on the right side on a sheet surface of the battery module 110 will be referred to as the end restraint member 300 (300a). The end restraint member 300 on the left side on the sheet surface of the battery module 110 will be referred to as the end restraint member 300 (300b). The expression of the “end restraint member 300” or “end restraint members 300 (300a, 300b)” denotes a generic name of the end restraint member 300 (300a) and the end restraint member 300 (300b).

In addition, the end restraint member 300 of each battery module 110 is coupled with another end restraint member 300 of another battery module 110, which is disposed to be adjacent along the second direction (Y direction), and a long-sized end restraint member 310 is configured. The long-sized end restraint member 310 on the right side on the sheet surface of the battery module 110 will be referred to as the long-sized end restraint member 310 (310a). The long-sized end restraint member 310 on the left side on the sheet surface of the battery module 110 will be referred to as the long-sized end restraint member 310 (310b). The expression of the “long-sized end restraint member 310” or “long-sized end restraint members 310 (310a, 310b)” denotes a generic name of the long-sized end restraint member 310 (310a) and the long-sized end restraint member 310 (310b).

In addition, in a side view of XZ plane (the first surface 101), the second surface 102 (YZ plane) on one end side in X direction of the battery module 110 will be referred to as the second surface 102 (102a), and the second surface 102 (YZ plane) on the other end side in X direction will be referred to as the second surface 102 (102b). The expression of the “second surface 102 (YZ plane)” or “second surfaces 102 (102a, 102b)” denotes a generic name of the second surface 102 (102a) and the second surface 102 (102b).

The end restraint member 300 is a plate-shaped member made of, for example, metal such as aluminum, an aluminum alloy, copper, iron, an iron alloy, or stainless steel. The shape of the end restraint member 300 is not particularly limited, as long as it is possible to hold and restrain the second surface 102 (YZ surface) of the battery module 110 (the stacked body 111).

In 1D of FIG. 1, in a side view of XZ plane direction, the pair of end restraint members 300 (300a, 300b) extend to face the second surface 102 (102a) on one end side in X direction of the battery module 110 and the second surface 102 (102b) on the other end side in X direction. That is, the end restraint member 300 (300a) faces the second surface 102 (102a) on one end side in X direction, and the end restraint member 300 (300b) faces the second surface 102 (102b) on the other end side in X direction.

The end restraint member 300 can function as a member for holding and restraining a disposed direction (Y direction: the second direction) of the battery module 110 (the stacked body 111), also giving the strength rigidity to the battery module 110 (the stacked body 111), and protecting the battery module 110.

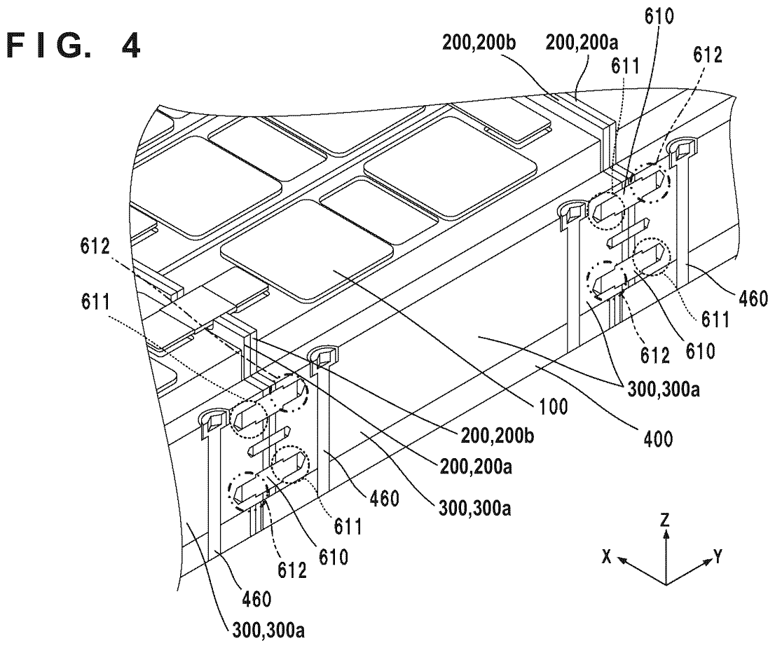

The end restraint members 300 (300a, 300b) of each battery modules 110 are coupled to extend along the second direction (Y direction). The end restraint members 300 (300a, 300b), which are coupled along the second direction (Y direction), are configured as the long-sized end restraint members 310 (310a, 310b). The long-sized end restraint members 310 (310a, 310b) can function as a member for holding and restraining the disposed direction (Y direction: the second direction) of the assembly of the plurality of battery modules 110 (the battery module group 115), also giving the strength rigidity to the battery module group 115, and protecting the battery module group 115. A coupling structure for coupling the end restraint members 300 will be described with reference to FIGS. 4 to 6. Note that in the following description, an example in which the plurality of end restraint members 310a and 310b are coupled to respectively constitute the long-sized end restraint members 310 (310a, 310b) will be described. However, without being limited to this example, the plurality of battery modules 110 may be held and restrained by one end restraint member 310. In such a case, it is sufficient if the plurality of battery modules 110 are held and restrained by such one end restraint member 310 having a length similar to that of the long-sized end restraint member 310, which is obtained by the coupling structure. That is, the end restraint member 310 may be configured as one long-sized end restraint member in the direction along the second surface 102 (YZ plane) of the battery module 110, and such one long-sized end restraint member 310 may be configured to hold the plurality of battery modules 110, which are disposed in the direction of the second surface 102. The end restraint member 310 serves as a rigid body. Therefore, by holding and restraining the plurality of battery modules 110 with this configuration, the side frame of the case and the end plate that constitutes the battery module can be integrated together, so that improvement in mount efficiency is enabled, while an increase in weight of the battery module is suppressed.

In 1E of FIG. 1, an assembly of the battery modules 110 (the battery module group 115) is illustrated in which the plurality of battery modules 110 are disposed in the disposed direction (Y direction: the second direction).

In 1E of FIG. 1, six battery modules 110 are disposed, but any number of battery modules 110, which constitute the battery module group 115, is applicable. An electrical component part 116 is attached to each of the battery modules 110, which constitute the battery module group 115. Examples of the electrical component part 116 include a conductive member (a bus bar) that electrically connects terminals between the battery cells 100, which constitute the stacked body 111, a voltage detection line that detects a voltage from each battery cell 100, and the like.

In the battery module group 115, the side restraint members 200 (200a, 200b) of each battery module 110 can function as a member for holding and restraining the stacked direction (X direction: the first direction) of the battery modules 110 (the stacked body 111), also giving the strength rigidity to the battery modules 110 (the stacked body 111), and protecting the battery modules 110. That is, in the battery module group 115 including the plurality of battery modules 110, the side restraint members 200 (200a, 200b) have a function in which the cross member of the housing (the case) and a binding bar which constitutes the battery module in the related art are integrated together.

The function that has been performed by the cross member of the housing (the case) and the function that has been performed by the binding bar in the related art can be integrated into the side restraint members 200 (200a, 200b) in the battery module 110 and the battery module group 115 in the present embodiment.

In addition, the long-sized end restraint member 310 (310a, 310b) can function as a member for holding the disposed direction (Y direction: the second direction) of the assembly of the plurality of battery modules 110 (the battery module group 115), restraining the battery module group 115, also giving the strength rigidity to the battery module group 115, and protecting the battery module group 115.

The long-sized end restraint members 310 (310a, 310b) have a function in which the side frame of the housing (the case) and the end plate that constitutes a battery module in the related art are integrated together.

The function that has been performed by the side frame of the housing (the case) and the function that has been performed by the end plate in the related art can be integrated into the end restraint members 300 (300a, 300b) or the long-sized end restraint members 310 (310a, 310b) in the battery module 110 and the battery module group 115 in the present embodiment. Thus, the battery module 110 and the battery module group 115 including the plurality of battery modules 110 have sufficient strength rigidity.

### Battery Pack 500

A battery pack 500 is constituted by mounting (disposing) the plurality of battery modules 110 (the battery module group 115) on the case 400 for protecting from external force and covering the upper side with a cover 410. The battery pack 500 can be mounted on, for example, an electric vehicle such as a hybrid automobile or an EV, not illustrated.

FIG. 3 is a view for describing a structure in which the battery module group 115 is disposed on the case 400 (the battery case). The case 400 is a tray-shaped case, and the bottom plate of the case 400 can be made up of a member having an insulating property and being excellent in thermal conductivity. A fastening member 460 is a member for fixing the battery module group 115 to the case 400, and examples thereof include a fastening bolt.

In the end restraint members 300 (300a, 300b) that have been described with reference to FIG. 1, hole portions (through holes) are formed to respectively enable the fastening members 460 for fixing the battery module group 115 to the case 400 to penetrate through. In the case 400, for example, screw portions (for example, female screws) to be respectively screwed with the fastening members 460 (for example, fastening bolts) are formed. A control unit 420, which controls electric power supplied from the battery module group 115, and an interface unit 430, which includes a connector or the like for connection with an external device, are attached to the case 400.

A frame 450 for reinforcing the case 400 is attached to the lower surface of the case 400. The frame 450 is a member that extends along one side (for example, in FIG. 3, the side in Y direction) of the case 400. The frame 450 contributes to improvement in the strength rigidity of the case 400. In order to reduce the weight of the battery pack 500, the frame 450 may have a substantially hollow structure in which a reinforcing portion 455 such as a rib is formed on an upper side of the extending direction (for example, in FIG. 3, Z direction). The number of reinforcing portions 455 is not particularly limited, as long as at least one reinforcing portion 455 is formed. In addition, in the example of FIG. 3, the frame 450 extends along Y direction of the case 400. However, the extending direction of the frame 450 is not limited to Y direction, and the frame 450 along X direction may be additionally provided.

A frame fastening member 470 is a member for fixing the frame 450 to the case 400, and examples thereof include a fastening bolt. In the frame 450, hole portions (through holes) are formed to respectively enable the frame fastening members 470 for fixing the frame 450 to the case 400 to penetrate through. In the case 400, for example, screw portions (for example, female screws) are formed to be respectively screwed with the frame fastening members 470 (for example, fastening bolts).

The cover 410 is a member that covers the upper side of the battery module group 115 (the plurality of battery modules 110) disposed in the case 400, and is fastened to the case 400 with a fastening member, not illustrated. Accordingly, the battery module group 115 is sealed, and the battery pack 500 is configured.

In the configuration of the battery module group 115, by integrating the functions of the structural members into the side restraint members 200 and the end restraint members 300, it becomes possible to reduce the weight of the battery module group 115. Furthermore, by integrating the functions of the structural members, it becomes possible to provide the battery pack 500, in which improvement in the mount efficiency of the battery module 110 in the case 400 is enabled.

### Coupling Structure Example 1

The end restraint member 300 of each battery module 110 is coupled with another end restraint member 300 of another battery module 110, which is disposed to be adjacent along the second direction (Y direction), and the long-sized end restraint member 310 is configured.

FIG. 4 is a view illustrating a coupling structure example 1 for coupling between the end restraint members 300 (300a) according to an embodiment. In the coupling structure example 1, a coupling structure with use of coupling pins 610 will be described. In the example of FIG. 4, description will be made assuming that one end restraint member 300 (300a) is coupled with another end restraint member 300 (300a). One end restraint member 300 (300a) is coupled with another end restraint member 300 (300a) by fitting of the coupling pin 610, which abuts both one end restraint member 300 (300a) and another end restraint member 300 (300a).

Recessed portions 611 and 612 to be fit with the coupling pin 610 are formed on YZ plane of one end restraint member 300 (300a). The coupling pin 610 is fit into the recessed portion 611 (a first fitting portion) in one end restraint member 300 (300a) and the recessed portion 612 (a second fitting portion) in another end restraint member 300 (300a), and thus one end restraint member 300 (300a) and another end restraint member 300 (300a) are coupled with each other.

The respective fitting portions may be formed in different shapes such that a fitting state in the recessed portion 611 (the first fitting portion) and a fitting state in the recessed portion 612 (the second fitting portion) are different from each other, in a state in which the coupling pin 610 is fit in the recessed portion 611 (the first fitting portion) and the recessed portion 612 (the second fitting portion). For example, as the different shapes, for example, the opening dimensions of the recessed portions may be different from each other so that dimensional tolerances are different from each other.

In a state in which the coupling pin 610 is fit in the recessed portion 611 (the first fitting portion) and the recessed portion 612 (the second fitting portion), the respective fitting portions may be formed to have surface roughness such that the fitting state in the recessed portion 611 (the first fitting portion) and the fitting state in the recessed portion 612 (the second fitting portion) are different from each other.

For example, the recessed portion 611 may be formed to be in a tight-fitting state (a first fitting state). In addition, the recessed portion 612 may be formed to be in a loose-fitting state (a second fitting state) loosened in comparison with the first fitting state.

In the example of FIG. 4, at least the recessed portions 611 and 612 of different types are formed on YZ plane of one end restraint member 300 (300a). That is, it is sufficient if the recessed portion 611 for the first fitting state and the recessed portion 612 for the second fitting state are formed on YZ plane of one end restraint member 300 (300a).

The side restraint member 200 (200a) in one battery module 110 is coupled with (abuts) one end restraint member 300 (300a). In addition, the side restraint member 200 (200b) in another battery module 110, which is adjacent, is coupled with (abuts) another end restraint member 300 (300a).

When the end restraint members 300 (300a) are coupled with each other, the side restraint member 200 (200a) and the side restraint member 200 (200b), which are adjacent to each other, are held while being sandwiched by one end restraint member 300 (300a) and another end restraint member 300 (300a).

In the end restraint members 300 (300a), hole portions (through holes) are formed to respectively enable the fastening members 460 to penetrate through, and the end restraint members 300 (300a) are coupled with the case 400, in which the battery modules 110 are disposed, by the fastening members 460.

The battery module 110, XZ plane of which is held by the side restraint members 200 (200a, 200b), is held by (coupled with) the case 400 through the side restraint members 200 (200a, 200b) and the end restraint members 300 (300a, 300b).

Note that also in the end restraint members 300 (300b) on the other end side of the battery module 110, it becomes possible to couple between the end restraint members 300 (300b), which are adjacent to each other, similarly by the coupling structure example 1.

In the coupling structure with use of the coupling pins 610, one side is set to the tight-fitting state (the first fitting state), and the other side is set to the loose-fitting state (the second fitting state). Thus, the assembling performance at the time of coupling the end restraint members 300 is improved. That is, also before the end restraint members 300 are coupled with each other, it becomes easy to align the side restraint members 200 in each battery module 110, so that the positional relationship between the side restraint members 200 and the end restraint members 300 is made easily adjustable.

### Coupling Structure Example 2

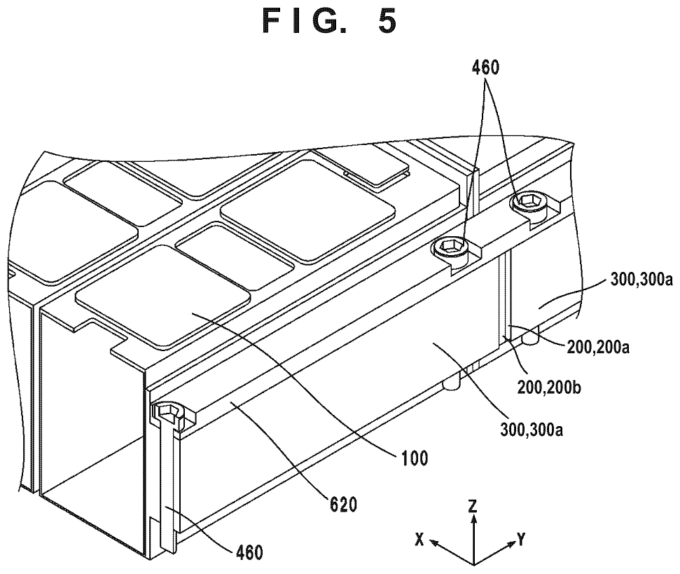

FIG. 5 is a view illustrating a coupling structure example 2 for coupling between the end restraint members 300 (300a) according to an embodiment. In the coupling structure example 2, a coupling structure with use of a stiffener 620 will be described. Also in the example of FIG. 5, similarly to the coupling structure example 1, description will be made assuming that one end restraint member 300 (300a) is coupled with another end restraint member 300 (300a).

Note that also in the coupling structure example 2, similarly to the coupling structure example 1, the side restraint member 200 (200a) in one battery module 110 is coupled with (abuts) one end restraint member 300 (300a). In addition, the side restraint member 200 (200b) in another battery module 110, which is adjacent, is coupled with (abuts) another end restraint member 300 (300a).

When the end restraint members 300 (300a) are coupled with each other, the side restraint member 200 (200a) and the side restraint member 200 (200b), which are adjacent to each other, are held while being sandwiched by one end restraint member 300 (300a) and another end restraint member 300 (300a).

As illustrated in FIG. 5, the stiffener 620 is a long-sized reinforcing member that extends in Y direction, and the length of the stiffener 620 is optional in accordance with the number of end restraint members 300 to be coupled. In the example illustrated in FIG. 5, the long-sized stiffener 620 is provided on the upper surface (XY plane) of one end restraint member 300 (300a) and another end restraint member 300 (300a).

In the long-sized stiffener 620, one end restraint member 300 (300a), and another end restraint member 300 (300a), hole portions (through holes) are formed to respectively enable the fastening members 460 to penetrate through. The long-sized stiffener 620, one end restraint member 300 (300a), and another end restraint member 300 (300a) are fastened together in the vertical direction (Z direction) by the fastening members 460, and are coupled with the case 400. Thus, one end restraint member 300 (300a) and another end restraint member 300 (300a) are coupled with each other.

Note that also in the end restraint members 300 (300b) on the other end side of the battery module 110, it becomes possible to couple between the end restraint members 300 (300b), which are adjacent to each other, similarly by the coupling structure example 2.

Also in the coupling structure example 2, the battery module 110, XZ plane of which is held by the side restraint members 200 (200a, 200b), is held by (coupled with) the case 400 through the side restraint members 200 (200a, 200b) and the end restraint members 300 (300a, 300b).

### Coupling Structure Example 3

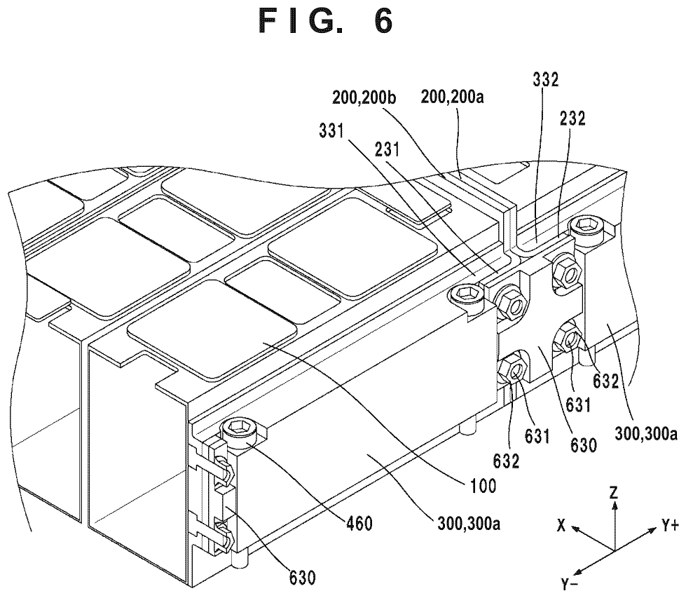

FIG. 6 is a view illustrating a coupling structure example 3 for coupling between the end restraint members 300 according to an embodiment. In the coupling structure example 3, a coupling structure with use of a stiffener 630 will be described. Also in the example of FIG. 6, similarly to the coupling structure example 1, description will be made assuming that one end restraint member 300 (300a) is coupled with another end restraint member 300 (300a).

Note that also in the coupling structure example 3, one side restraint member 200 (200a) in one battery module 110 is coupled with (abuts) one end restraint member 300 (300a). In addition, the other side restraint member 200 (200b) in the other battery module 110, which is adjacent, is coupled with (abuts) another end restraint member 300 (300a).

As illustrated in FIG. 6, in one side restraint member 200 (200a), a flange 232 (a first flange) is formed in Y direction (Y+ direction) at an end portion of one side restraint member 200 (200a), and a step 332 (a first step), which can be coupled with (abut) the flange 232, is formed in the aforementioned one end restraint member 300 (300a).

In addition, in the other side restraint member 200 (200b), a flange 231 (a second flange) is formed in Y direction (Y− direction) at an end portion of the other side restraint member 200 (200b), and a step 331 (a second step), which can be coupled with (abut) the flange 231, is formed in the aforementioned the other end restraint member 300 (300a).

Screw portions 631 (for example, male screws) to be respectively screwed with the fastening members 632 (for example, fastening nuts) are formed in each of the steps 331 and 332.

As illustrated in FIG. 6, the stiffener 630 is a reinforcing member that reinforces YZ planes of the end restraint members 300 (300a).

In the stiffener 630, the flange 231, and the flange 232, the hole portions (the through holes) are formed to respectively enable the screw portions 631 formed on the steps 331 and 332 to penetrate through. The stiffener 630, the flange 231, and the flange 232 are fastened together to the steps 331 and 332 by the fastening members 632. Thus, one end restraint member 300 (300a) and another end restraint member 300 (300a) are coupled with each other.

Note that also in the end restraint members 300 (300b) on the other end side of the battery module 110, it becomes possible to couple between the end restraint members 300 (300b), which are adjacent to each other, similarly by the coupling structure example 3.

Also in the coupling structure example 3, the battery module 110, XZ plane of which is held by the side restraint members 200 (200a, 200b), is held by (coupled with) the case 400 through the side restraint members 200 (200a, 200b) and the end restraint members 300 (300a, 300b).

In order to integrate the functions of the structural member (the side frame) provided in the housing and the structural member (the end plate) that constitutes the battery module that have been described in the related art, the long-sized end plate has to be a rigid body. On the other hand, when assembling the long-sized end plate to the housing, it is difficult to finely adjust an assembling position or the like. Thus, the assembling performance may be degraded.

In the above coupling structure example 2 and the coupling structure example 3, the end restraint members 300 are coupled with each other with use of the stiffener, and a pseudo long-sized end plate is configured. According to the pseudo long-sized end plate in which the plurality of end restraint members 300 are coupled with each other with use of the stiffener, the rigidity of the coupling part can be improved. In addition, fine adjustments of the assembling position are enabled in each end restraint member 300. Thus, the assembling performance can be improved. Furthermore, improvement in mount efficiency is enabled, while an increase in weight of the battery module is suppressed.

### Battery Cell

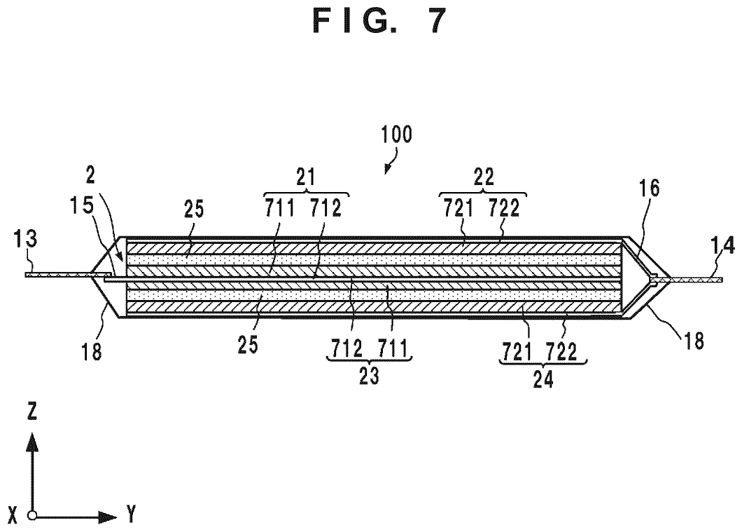

FIG. 7 is a view illustrating a cross-sectional structure (XZ cross-section) of the battery cell 100. The battery cell 100 (the secondary battery) may be an all-solid-state battery.

In the coordinate system in the drawing, Y axis indicates the longitudinal direction of the battery cell 100 (an extending direction of a lead tab), and Z axis indicates the thickness direction of the battery cell 100 (the thickness direction of an electrode body 2).

The battery cell 100 includes: the electrode body 2 (also referred to as the stacked body in the present embodiment), which is an electric power storage device in which a positive electrode layer, a solid electrolyte layer and a negative electrode layer are laminated; an exterior member 18, which seals the periphery of the electrode body 2 that is accommodated; lead tabs 13 and 14; and current collecting tabs 15 and 16.

The electrode body 2 has a two-layered structure of the positive electrode layer and the negative electrode layer. The positive electrode layer includes two layers of positive electrode layers 21 and 23, and the negative electrode layer includes two layers of negative electrode layers 22 and 24. A solid electrolyte layer 25 is provided between the positive electrode layer 21 and the negative electrode layer 22. Similarly, the solid electrolyte layer 25 is provided between the positive electrode layer 23 and the negative electrode layer 24. Note that the positive electrode layer and the negative electrode layer may be a single layer (one layer), or may be constituted of a plurality of layers. In a case where a plurality of positive electrode layers and a plurality of negative electrode layers are provided, as illustrated in FIG. 7, a solid electrolyte layer is provided between each positive electrode layer and each negative electrode layer. In the example of FIG. 7, the structure in which the positive electrode layer and the negative electrode layer each have two layers is illustrated as an example. However, without being limited to this example, the positive electrode layer and the negative electrode layer may each have three or more layers.

The positive electrode layers 21 and 23 each include a positive electrode active material layer 711 and a positive electrode current collector 712. The positive electrode current collector 712 is common to the two positive electrode layers 21 and 23. The positive electrode current collector 712 is disposed at the center in the thickness direction (Z direction) of the electrode body 2, and the positive electrode active material layer 711 of the positive electrode layer 21 and the positive electrode active material layer 711 of the positive electrode layer 23 are respectively laminated on an upper surface side and a lower surface side of the positive electrode current collector 712.

The negative electrode layer 22 is disposed (laminated) on an upper surface side in the thickness direction (Z direction) of the electrode body 2 with respect to the positive electrode layer 21, and the negative electrode layer 24 is disposed (laminated) on a lower surface side in the thickness direction (Z direction) of the electrode body 2 with respect to the positive electrode layer 23. The negative electrode layers 22 and 24 are laminated so as to sandwich the positive electrode layers 21 and 23. The negative electrode layers 22 and 24 each include a negative electrode active material layer 721 and a negative electrode current collector 722. The two negative electrode current collectors 722 are each formed in a layered form at an outermost layer of the electrode body 2. Note that the configurations of the positive electrode layer and the negative electrode layer are not limited to the laminated order as illustrated in FIG. 7. A configuration in which two positive electrode layers are laminated to sandwich two negative electrode layers may be adopted.

Examples of an active material that constitutes the positive electrode active material layer 711 include NCM-based materials (ternary active materials) in which cobalt, nickel, and manganese are mixed, for example, lithium cobaltate, lithium nickelate, lithium manganate, and the like.

In addition, examples of an active material that constitutes the negative electrode active material layer 721 include a lithium-based material, a silicon-based material, and the like. Other examples of the material that constitutes the negative electrode active material layer 721 include a carbon material, such as graphite, soft carbon, and hard carbon, a tin-based material, a transition metal oxide-based material (for example, lithium titanate: LTO), and the like.

The solid electrolyte layer 25 is made of, for example, a solid electrolyte having ion conductivity. As its material, a sulfide-based solid electrolyte material, an oxide-based solid electrolyte material, a nitride-based solid electrolyte material, and halide-based solid electrolyte material, and the like can be mentioned.

The positive electrode current collector 712 and the negative electrode current collector 722 are made of, for example, a metal foil such as aluminum, copper, or SUS, a metal sheet, or a metal plate. The positive electrode active material layer 711, the negative electrode active material layer 721, and the solid electrolyte layer 25 may be formed by bonding particles of substances that constitute them with an organic polymer compound-based binder. The positive electrode active material layer 711 or the negative electrode active material layer 721 may contain an electron conduction assistant such as carbon (particles or fibrous) or metal powder. In the positive electrode active material layer 711 or the negative electrode active material layer 721, solid electrolyte powders can also be disposed to construct an ion conductive path.

The exterior member 18 is an accommodating body that accommodates the electrode body 2. The exterior member 18 is formed by folding one sheet-like material into two, or by bonding a plurality of sheet-like materials to each other. The material of the exterior member 18 is formed by, for example, covering the front and back surfaces of a metal layer with an insulation layer.

One end portion of the lead tab 13 is located outside the exterior member 18, and the other end portion is located inside the exterior member 18. The other end portion of the lead tab 13 is connected with the positive electrode current collector 712 through the current collecting tab 15 inside the exterior member 18, and the lead tab 13 forms a positive electrode tab. The lead tab 13 and the current collecting tab 15 are made of, for example, a conductive metal sheet or metal plate.

One end portion of the lead tab 14 is located outside the exterior member 18, and the other end portion is located inside the exterior member 18. The other end portion of the lead tab 14 is connected with the negative electrode current collector 722 through the current collecting tab 16 inside the exterior member 18, and the lead tab 14 forms a negative electrode tab. The lead tab 14 and the current collecting tab 16 are made of, for example, a conductive metal sheet or metal plate. The electrode body 2 can be charged or discharged by connecting the lead tabs 13 and 14 to a charger or an electric load.

### Summary of Embodiments

The above embodiments disclose at least the battery module and the battery pack in the following.

(Item 1) The battery module (110) in the above embodiments includes:

the stacked body (111) in which the plurality of secondary batteries (100) are stacked; and

the side restraint member (200) which faces the first surface of the stacked body, and which extends in the stacked direction (X direction) of the stacked body, in which

the first surface (101) is a surface in a vertical direction with respect to the lower surface (XY surface) of the stacked body, and is a surface along the stacked direction (X direction), and

the first surface (101) and the side restraint member (200) are joined with each other by the joining member (701).

According to the battery module in the item 1, it is possible to provide the battery module in which improvement in mount efficiency is enabled, while an increase in weight of the battery module is suppressed. It is possible to provide the battery module in which the cross member of the case and the binding bar that constitutes the battery module are integrated together.

(Item 2) In the case (400) in which the battery module (110) is disposed, a plurality of the battery modules (110) are disposed in an intersecting direction that intersects the first surface of the stacked body, and

the side restraint member (200 (200a)) is disposed facing, in the intersecting direction, another side restraint member (200 (200b)) of another battery module that is disposed to be adjacent in the case.

According to the battery module in the item 2, the function that has been performed by the cross member of the housing (the case) and the function that has been performed by the binding bar in the related art can be integrated into the side restraint members 200 (200a, 200b) in the battery module 110 and the battery module group 115 in the present embodiment.

(Item 3) One long-sized end restraint member configured in a direction along a second surface of the stacked body, in the direction that intersects the first surface of the stacked body, holds a plurality of battery modules disposed in the direction along the second surface.

(Item 4) The end restraint member (300) is further included that holds the second surface of the stacked body in the direction that intersects the first surface of the stacked body, and that is coupled with the side restraint member, in which

the end restraint member (300) is

coupled with the case in which the battery module is disposed.

(Item 5) The end restraint member (300) is configured to be capable of being coupled with another end restraint member (300) in a direction along the second surface, and

the plurality of end restraint members including the end restraint member (300) and the other end restraint member (300) hold the plurality of battery modules (110) disposed in the direction along the second surface.

According to the battery modules in the items 3, 4, and 5, it is possible to provide the battery module in which improvement in mount efficiency is enabled, while an increase in weight of the battery module is suppressed. It is possible to provide the battery module in which the side frame of the case and the end plate that constitutes the battery module are integrated together.

(Item 6) The battery module (110) is

held by the case (400) through the side restraint member (200) and the end restraint member (300).

According to the battery module in the item 6, the battery module can be held in the case without the use of the cross member of the housing (the case) or the side frame of the housing (the case) in the related art.

(Item 7) The end restraint member (300) is coupled with another end restraint member (300) of the other battery module that is disposed to be adjacent in the intersecting direction in the case.

(Item 8) The end restraint member (300) is coupled with the other end restraint member by fitting of a coupling pin (610) that abuts both the end restraint member and the other end restraint member.

(Item 9) The first fitting portion (611) to be fit with the coupling pin is formed in the end restraint member (300), and the second fitting portion (612) to be fit with the coupling pin is formed in the other end restraint member, and

the coupling pin (610) is fit with the first fitting portion (611) and the second fitting portion (612), and the end restraint member (300) and the other end restraint member (300) are coupled with each other.

(Item 10) The first fitting portion (611) and the second fitting portion (612) are formed to be different in shape from each other,

such that a fitting state of the first fitting portion (611) is different from a fitting state of the second fitting portion (612) in a state in which the coupling pin (610) is fit with the first fitting portion (611) and the second fitting portion (612).

(Item 11) The first fitting portion (611) and the second fitting portion (612) are formed to be different in surface roughness from each other,

such that a fitting state of the first fitting portion (611) is different from a fitting state of the second fitting portion (612) in a state in which the coupling pin (610) is fit with the first fitting portion (611) and the second fitting portion (612).

(Item 12) The stiffener (620, 630) that abuts both the end restraint member and the other end restraint member is fastened together by the fastening member (460, 632), and the end restraint member (300) and the other end restraint member (300) are coupled with each other.

(Item 13) The fastening member (460) is a fastening member that couples the end restraint member (300) to the case (400).

(Item 14) The stiffener (630) that abuts both the first flange (232) formed in an end portion of the side restraint member (200) and the second flange (231) formed in an end portion of another side restraint member in the other battery module are fastened together by the fastening member (632), and the end restraint member (300) and the other end restraint member (300) are coupled with each other.

(Item 15) The first step (332) capable of abutting the first flange (232) is formed in the end restraint member (300), and the second step (331) capable of abutting the second flange (231) is formed in the other end restraint member, and

the fastening member (632) is a fastening member to be screwed with the screw portions (631) formed in the first step (332) and the second step (331).

According to the battery module in the items 7 to 15, the long-sized end restraint members 310, which are coupled with each other, have a function in which the side frame of the housing (the case) and the end plate that constitutes the battery module in the related art are integrated together.

The function that has been performed by the side frame of the housing (the case) and the function that has been performed by the end plate in the related art can be integrated into the end restraint member and the long-sized end restraint member that is coupled. Thus, the battery module and the battery module group including the plurality of battery modules have sufficient strength rigidity.

(Item 16) The battery pack in the above embodiments is the battery pack (500) in which a plurality of battery modules are disposed in a case,

each of the plurality of battery modules (110) includes:

the stacked body (111) in which a plurality of secondary batteries are stacked;

the side restraint member (200) which faces the first surface of the stacked body, and which extends in the stacked direction (X direction) of the stacked body, in which

the first surface (101) is a surface in a vertical direction with respect to the lower surface (XY surface) of the stacked body, and is a surface along the stacked direction (X direction), and

the first surface and the side restraint member are joined with each other by the joining member.

According to the battery pack in the item 16, it is possible to provide the battery pack including the battery module in which improvement in mount efficiency is enabled, while an increase in weight of the battery module is suppressed.

The invention is not limited to the foregoing embodiments, and various variations/changes are possible within the spirit of the invention

What is claimed is:

1. A battery module comprising:
a stacked body in which a plurality of secondary batteries are stacked; and
a side restraint member which faces a first surface of the stacked body, and which extends in a stacked direction of the stacked body,
wherein the first surface is a surface in a vertical direction with respect to a lower surface of the stacked body, and is a surface along the stacked direction, and
the first surface and the side restraint member are joined with each other by a joining member.

2. The battery module according to claim 1, wherein, in a case in which the battery module is disposed, a plurality of the battery modules are disposed in an intersecting direction that intersects the first surface of the stacked body, and
the side restraint member is disposed facing, in the intersecting direction, another side restraint member of another battery module that is disposed to be adjacent in the case.

3. The battery module according to claim 2, wherein one long-sized end restraint member configured in a direction along a second surface of the stacked body, in the direction that intersects the first surface of the stacked body, holds a plurality of battery modules disposed in the direction along the second surface.

4. The battery module according to claim 2, further comprising an end restraint member that holds a second surface of the stacked body in the direction that intersects the first surface of the stacked body, and that is coupled with the side restraint member,
wherein the end restraint member is coupled with the case in which the battery module is disposed.

5. The battery module according to claim 4, wherein the end restraint member is configured to be capable of being coupled with another end restraint member in a direction along the second surface, and
the plurality of end restraint members including the end restraint member and the other end restraint member hold a plurality of battery modules disposed in the direction along the second surface.

6. The battery module according to claim 4, wherein the battery module is held by the case through the side restraint member and the end restraint member.

7. The battery module according to claim 4, wherein the end restraint member is coupled with another end restraint member of the other battery module that is disposed to be adjacent in the intersecting direction in the case.

8. The battery module according to claim 7, wherein the end restraint member is coupled with the other end restraint member by fitting of a coupling pin that abuts both the end restraint member and the other end restraint member.

9. The battery module according to claim 8, wherein a first fitting portion to be fit with the coupling pin is formed in the end restraint member, and a second fitting portion to be fit with the coupling pin is formed in the other end restraint member, and
the coupling pin is fit with the first fitting portion and the second fitting portion, and the end restraint member and the other end restraint member are coupled with each other.

10. The battery module according to claim 9, wherein the first fitting portion and the second fitting portion are formed to be different in shape from each other,
such that a fitting state of the first fitting portion is different from a fitting state of the second fitting portion in a state in which the coupling pin is fit with the first fitting portion and the second fitting portion.

11. The battery module according to claim 9, wherein the first fitting portion and the second fitting portion are formed to be different in surface roughness from each other,
such that a fitting state of the first fitting portion is different from a fitting state of the second fitting portion in a state in which the coupling pin is fit with the first fitting portion and the second fitting portion.

12. The battery module according to claim 7, wherein a stiffener that abuts both the end restraint member and the other end restraint member is fastened together by a fastening member, and the end restraint member and the other end restraint member are coupled with each other.

13. The battery module according to claim 12, wherein the fastening member is a fastening member that couples the end restraint member to the case.

14. The battery module according to claim 7, wherein a stiffener that abuts both a first flange formed in an end portion of the side restraint member and a second flange formed in an end portion of another side restraint member in the other battery module are fastened together by a fastening member, and the end restraint member and the other end restraint member are coupled with each other.

15. The battery module according to claim 14, wherein a first step capable of abutting the first flange is formed in the end restraint member, and a second step capable of abutting the second flange is formed in the other end restraint member, and
the fastening member is a fastening member to be screwed with a screw portions formed in the first step and the second step.

16. A battery pack in which a plurality of battery modules are disposed in a case,
wherein each of the plurality of battery modules comprising:
a stacked body in which a plurality of secondary batteries are stacked; and
a side restraint member which faces a first surface of the stacked body, and which extends in a stacked direction of the stacked body,
wherein the first surface is a surface in a vertical direction with respect to a lower surface of the stacked body, and is a surface along the stacked direction, and
the first surface and the side restraint member are joined with each other by a joining member.
